(19) United States
(12) Patent Application Publication
(10) Pub. No.: US 2007/0104176 A1
(43) Pub. Date: May 10, 2007

(54) System and method for pilot signal utilization in an environment using dynamic frequency assignment

(75) Inventors: Baowei Ji, Richardson, TX (US); William Joseph Semper, Richardson, TX (US)

Correspondence Address: TIMOTHY F. BLISS, P.O. BOX 793968, DALLAS, TX, 75379-3968, US

(73) Assignee: Samsung Electronics Co., Ltd., Suwon-city (KR)

(21) Appl. No.: 11/588,028

(22) Filed: Oct. 26, 2006

Related U.S. Application Data
(60) Provisional application No. 60/735,972, filed on Nov. 10, 2005.

(51) Int. Cl. H04B 7/212

(52) U.S. Cl. 370/348; 370/320; 370/350

(57) ABSTRACT

The present disclosure relates generally to systems and methods for pilot signal utilization in an environment using dynamic frequency assignment. In one example, a method for a wireless device includes identifying a pilot signal of a base station in a frequency division duplex wireless system. A reverse access channel identifier and a forward signaling channel identifier are obtained from the pilot signal and communication is initiated with the base station via the reverse access channel. A set of candidate channels available for use by the wireless device is sensed and reported to the base station.

### CLAIM OF PRIORITY

This application claims priority from U.S. Provisional Patent Application Ser. No. 60/735,972, filed on Nov. 10, 2005, and entitled “SYSTEMS AND METHODS FOR COMMUNICATIONS”, which is hereby incorporated by reference in its entirety.

### BACKGROUND

Wireless communication systems use frequency channels to communicate with wireless devices. The frequency channels may be divided into downlink and uplink channels when communicating with a wireless device. The downlink channel is for communications sent from the system to the wireless device and the uplink channel is for communications sent from the wireless device to the system. Generally, the frequency channels in a large scale wireless system are predefined. For example, in wireless systems based on technologies such as code division multiple access (CDMA) or Global System for Mobile communication (GSM), the downlink and uplink channel frequencies may be predetermined and assigned to the system. The frequency channel assignments may take such issues as inter-cell interference into consideration. In such systems, due to the assigned frequency channels and predefined downlink/uplink channel pair relationships, the wireless device may automatically know the frequency of the uplink channel after synchronizing to a corresponding downlink channel.

However, in wireless systems using dynamically assigned frequencies, there may not be predefined frequency channel assignments and/or predefined relationships between the downlink and uplink channels. Accordingly, what is needed are a system and method for notifying a wireless device of available downlink and uplink channels and enabling the wireless device to communicate with the system using those channels.

### SUMMARY

In one embodiment, a method for a wireless device comprises identifying a pilot signal of a base station in a frequency division duplex wireless system, and obtaining a reverse access channel identifier and a forward signaling channel identifier from the pilot signal. The method initiates communication with the base station via a reverse access channel corresponding to the reverse access channel identifier, senses a set of candidate channels available for use by the wireless device, and reports the set of candidate channels to the base station.

In another embodiment, a wireless device comprises a wireless interface configured to receive and transmit wireless signals, a processor coupled to the wireless interface, a memory coupled to the processor and configured to store a plurality of instructions, and the plurality of instructions. The plurality of instructions includes instructions for searching for a pilot signal transmitted by a base station in a frequency division duplex wireless network, obtaining reverse access channel information from the pilot signal, obtaining forward signaling channel information from the pilot signal, and contacting the base station via a reverse access channel extracted from the reverse access channel information. The instructions also include instructions for receiving a first directive from the base station via a forward signaling channel extracted from the forward signaling channel information to search for a first set of candidate channels, searching for the first set of candidate channels, and reporting at least one candidate channel identified during the search for the first set of candidate channels to the base station.

In yet another embodiment, a method for use by a base station comprises generating a pilot signal in a frequency division duplex wireless system, wherein the pilot signal includes uplink and downlink information. A message is received from a wireless device via an uplink channel defined in the uplink information and the wireless device is instructed to sense a first set of candidate channels via a downlink channel defined in the downlink information. A notification is received from the wireless device identifying at least one candidate channel available for use by the wireless device from the first set of candidate channels, and the wireless device is instructed to use at least one of the candidate channels from the first set of candidate channels identified as available for use.

In still another embodiment, a wireless communication system comprises a subdivision of a frequency division duplex wireless network and a base station providing wireless coverage for the subdivision, wherein the base station is coupled to a processor configured to execute instructions stored on a memory. The instructions include instructions for generating a pilot signal containing reverse access channel information and forward signaling channel information, receiving a message from a wireless device via a reverse access channel defined in the reverse access channel information, and instructing the wireless device via a forward signaling channel associated with the forward signaling channel information to use first and second frequency channels for downlink and uplink channels, respectively.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a flowchart illustrating one embodiment of a method for establishing a connection between a user device and a base station using uplink and downlink channel information contained in a pilot signal transmitted by the base station.

FIG. 2 is a diagram of one embodiment of a network in which the method of FIG. 1 may be implemented.

FIG. 3 is a flowchart illustrating another embodiment of a method for establishing a connection between a user device and a base station using uplink and downlink channel information contained in a pilot signal transmitted by the base station.

FIG. 4 is a flowchart illustrating still another embodiment of a method for establishing a connection between a user device and a base station using uplink and downlink channel information contained in a pilot signal transmitted by the base station.

FIG. 5 is a diagram of another embodiment of a network in which the method of FIG. 1 may be implemented.

FIG. 6 is a block diagram of one embodiment of a simplified user device.

FIG. 7 is a sequence diagram illustrating an embodiment of a sequence of events for establishing a connection between a user device and a base station of FIG. 5 using uplink and downlink channel information contained in a pilot signal transmitted by the base station.

### DETAILED DESCRIPTION

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Referring to FIG. 1, in one embodiment, a method 100 may be used by a user device (which may be referred to as Customer Premises Equipment (CPE)) to establish a connection with an access point (e.g., a base station (BS)) in a frequency division duplex (FDD) wireless system. In the present example, the wireless system may be a wireless regional access network (WRAN) that uses dynamic frequency selection. In such a wireless system, a dynamic frequency selection process may be used to identify and select frequencies for use by the system instead of relying on the assignment of predetermined frequencies. One example of dynamic frequency selection is described in U.S. patent application Ser. No. (Attorney Docket No. 2005.11.005.WS0/1005.10), filed on Sep. 25, 2006, and entitled “SYSTEM AND METHOD FOR DYNAMIC FREQUENCY SELECTION BASED ON SPECTRUM ETIQUETTE”, which is hereby incorporated by reference.

Dynamic frequency selection may be desirable, for example, as more of the frequency spectrum becomes available for license-exempted or light-licensing operations. In systems based on such concepts, each subdivision (e.g., cell or sector) of a network may dynamically identify and select frequencies with the consideration of avoiding inter-cell interference. The need for accomplishing such identification and selection dynamically is due in part to the difficulty of advance frequency planning in systems where frequency availability changes over time. In systems that must handle changing frequency availability, a centralized decision-making scheme may present issues such as scalability and point-of-failure. Although some simple schemes may exist for spectrum sharing negotiations between, for example, two neighboring cells, such schemes do not adequately the need for systematic dynamic frequency-sharing in large-scale wireless systems. Accordingly, dynamic frequency assignment processes may be used.

Due to the use of dynamically assigned frequencies, there may be no predefined relationship between downlink and uplink frequencies. In such a system, the CPE may not be allowed to initiate a transmission using any frequency unless directed by a BS to do so in order to avoid interference. However, in order to initiate the establishment of a connection with the system, the CPE may need information about how to contact the BS. Accordingly, as described below, the CPE may use information transmitted in a pilot signal generated by the BS in order to establish a connection. In addition, a downlink signaling channel also needs to be indicated so the BS can communicate with the CPE. This information may also be determined from information transmitted in the pilot signal.

In step 102, the CPE may identify a pilot signal from a BS. As will be described later in greater detail, the pilot signal may include information such as a BS identifier, downlink channel information, and uplink channel information. In the present example, the uplink channel information may include channel characteristics of a reverse access channel (RACH), such as frequency, bandwidth, power requirements, and/or parameters for resolving RACH contention. The uplink information carried by the pilot signal may vary depending on such factors as the particular configuration of the wireless system. For example, if the wireless system operates with a known RACH power requirement, then the power requirement may not be transmitted in the pilot signal. In the present example, the downlink channel information may include channel characteristics of a forward signaling channel (FSCH), such as frequency and bandwidth. The downlink information carried by the pilot signal may vary depending on such factors as the particular configuration of the wireless system.

It is understood that the uplink channel may include channels other than the RACH, and that the pilot signal may carry uplink information on other channels in some embodiments. Likewise, it is understood that the downlink channel may include channels other than the FSCH, and that the pilot signal may carry downlink information on other channels in some embodiments. For example, in a TDMA system, the uplink channel may be divided into traffic channels and signaling channels, and the signaling channels may be further divided into one or more broadcast channels, common control channels (which may include the RACH), and dedicated/associated control channels. Accordingly, although the present disclosure describes a pilot signal containing RACH and FSCH information for purposes of example, the present disclosure is not limited to RACH and FSCH information.

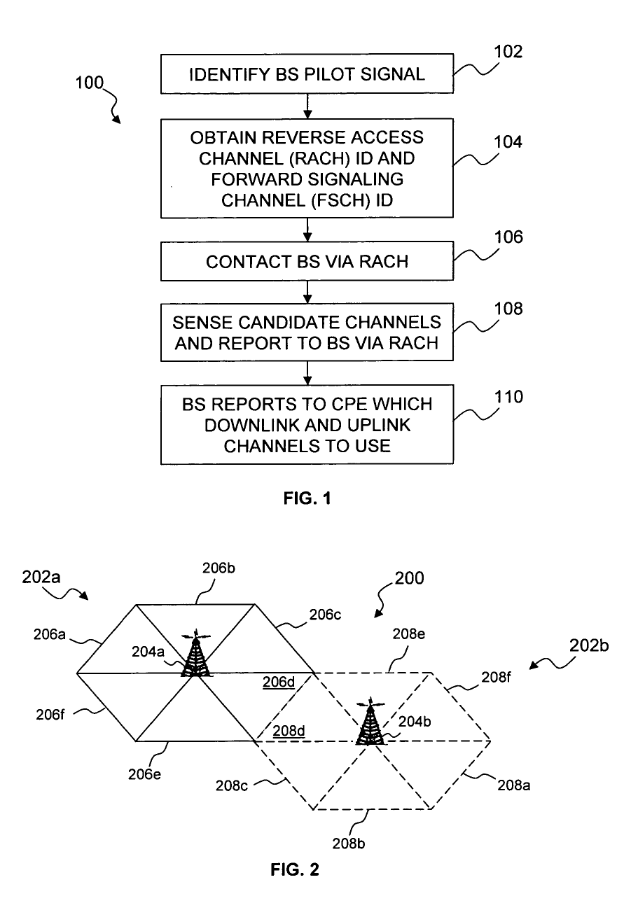

In step 104, the CPE may obtain the RACH ID and other RACH information as well as the FSCH ID and other FSCH information from the pilot signal and use the obtained information to initiate contact with the BS in step 106. In step 108, the CPE may sense candidate channels that are available for use by the CPE and report the candidate channels to the BS. For example, as will be described in greater detail with respect to FIG. 2, the CPE may sense television (TV) spectrum frequencies that are available (in terms of adequate power, etc.) to the CPE. These frequencies may then be reported to the BS.

In step 110, the BS uses the FSCH to direct the CPE to use a specific uplink channel and downlink channel for data transfer. In some embodiments, the BS may select the uplink and downlink channels from the candidate channels reported by the CPE in step 106. Accordingly, by receiving a pilot signal from the BS containing the information needed to communicate with the BS prior to knowing the downlink and uplink channel frequencies, the CPE may operate within the dynamic frequency assignment environment of the wireless network even though the CPE may not be allowed to initiate a transmission without first receiving permission from the BS (e.g., via the RACH information). Following step 110, the CPE and the BS use the assigned uplink and downlink channels for data transfer.

Referring to FIG. 2, one embodiment of a portion of a wireless network 200 is illustrated with cells 202a and 202b and corresponding BSes 204a and 204b. It is understood that the cells 202a and 202b may represent any subdivision (e.g., a cell, sector, or other network segment) of a wireless communication network, and that the terms “cell” and “sector” may be interchangeable depending on the configuration of a particular network. Although not shown, it is understood that BS 204a and BS 204b may include processors, memories, and other components that enable the base stations to receive, store, retrieve, process, and transmit instructions and data over wireless and/or wireline communication links. Furthermore, at least some functionality of a base station may be distributed and located elsewhere, either within a cell or outside of a cell. Repeaters (not shown) may be used to extend the range of the BS 204a and/or the BS 204b.

In the present example, the network 200 may be a WRAN, but it is understood that the wireless network 200 may represent many different types of wireless networks. In some embodiments, the wireless network 200 may be configured to use available television (TV) spectrum frequencies in certain areas (e.g., rural areas) to provide additional bandwidth to user terminals. For example, a fixed point-to-multipoint WRAN may be configured to use ultra high frequency and very high frequency (UHF/VHF) TV bands between 54 and 862 MHz. Such specifications may comply, for example, with those developed by the Institute of Electrical and Electronics Engineers (IEEE) 802.22 Working Group on WRANs. It is understood, however, that the present disclosure is not limited to TV spectrum frequencies and that other frequencies may be used in place of or in addition to those in the TV spectrum.

In the present example, the cells 202a and 202b are shown in a sectorized configuration. More specifically, the cell 202a is divided into sectors 206a-206f and the cell 202b is divided into sectors 208a-208f. To avoid inter-cell and inter-sector interference, neighboring cells and/or sectors should generally cooperate when deciding what frequency bands to use. In the network 200, each cell 202a and 202b may pick up an available frequency band dynamically, which forecloses the possibility of advance frequency planning and assignment. Without cooperation between the cells and/or sectors, the frequency selection in a particular cell may prevent neighboring cells from properly functioning. For example, assume that the available frequency channels at BS 204a and BS 204b are {1, 3} and {1, 2, 3}, respectively. If BS 204b decides to use channels {1, 3 }, then BS 204a has no available channel. Furthermore, cooperation may be used to facilitate load balancing within the wireless network 200. For example, if BS 204a is heavily loaded (e.g., has a large amount of traffic) and BS 204b is not heavily loaded, then BS 204a may use {1, 3} and BS 204b may use {2}. This provides BS 204a with additional bandwidth to handle its heavier load while allowing BS 204b to still provide service. Accordingly, each BS 204a and 204b may be configured to dynamically select frequencies to be used in its corresponding cells and/or sectors.

In the present example, each BS 204a and 204b may generate a pilot signal containing information such as a WRAN ID, BS ID, downlink channel information, and uplink channel information. The pilot signal may be designed to provide information to a CPE (not shown) in order for aid the CPE in frequency synchronization, timing synchronization, acquiring the WRAN ID and BS ID, and acquiring characteristics of the RACH such as frequency, bandwidth, power requirements, and/or parameters for resolving RACH contention (e.g., using slotted Aloha). The downlink channel information may contain similar information for the FSCH. By providing RACH and FSCH information and/or other needed uplink or downlink information in a pilot signal used in the wireless network 200, the CPE may communicate with the wireless network despite the wireless network's use of dynamic frequency assignments and any prohibition on transmission by the CPE without authorization from the wireless network.

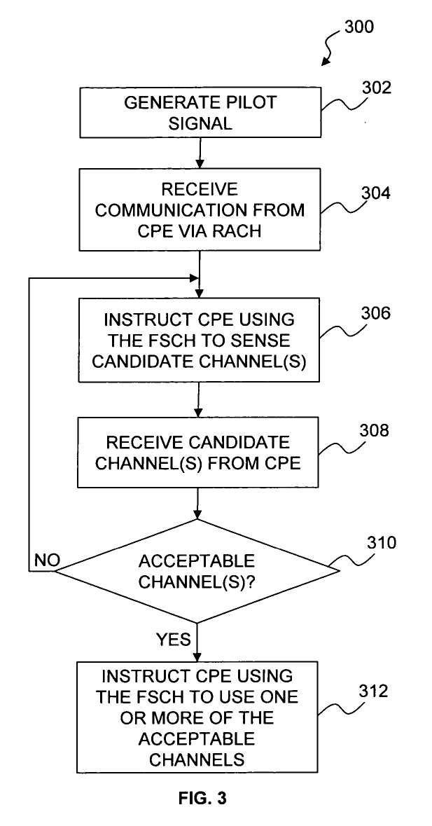

Referring to FIG. 3, in another embodiment, a method 300 may be used by a BS (e.g., the BS 204a of FIG. 2) within a system that uses dynamic frequency assignment, such as the wireless network 200 of FIG. 2. In step 302, in addition to BS ID and downlink channel information that may be traditionally transmitted in a pilot signal, the BS 204a may generate a pilot signal containing uplink channel information. The uplink information may include characteristics of a RACH (e.g., frequency, bandwidth, power requirements, and/or parameters for resolving RACH contention). The downlink information may include characteristics of a FSCH (e.g., frequency and/or bandwidth). In the present example, the CPE may only have permission to communicate with the BS 204a via the RACH at this time.

In step 304, the BS 204a may receive a communication from a CPE on the RACH. In step 306, the BS 204a may instruct the CPE using the FSCH to sense candidate channels that are available for use by the CPE. In the present example, the BS 204a may send a set of candidate channels to the CPE and instruct the CPE to determine whether it can detect any of the candidate channels. In other embodiments, the BS 204a may instruct the CPE to sense all available channels, or the CPE may sense the available candidate channels without being instructed by the BS 204a. In step 308, the BS 204a may receive a list of candidate channels sensed by the CPE. The list may include only candidate channels from a set provided by the BS 204a or may include all candidate channels.

In step 310, the BS 204a may determine whether the candidate channels (if any) reported by the CPE are acceptable. For example, if the CPE detected and reported all candidate channels to the BS 204a, the BS 204a may determine if any of the candidate channels can be used by the CPE without causing interference. If the CPE detected and reported only candidate channels from a list sent by the BS 204a, then step 310 may involve determining if the reported list of candidate channels contains the number of channels needed (e.g., for downlink and uplink channels). If the reported candidate channels are not acceptable (in number or otherwise), the method 300 may return to step 306. If acceptable candidate channels exist, the BS 204a may select one or more of the acceptable channels and instruct the CPE via the FSCH to use the selected channels in step 312. If only one channel is available and two or more are needed (e.g., for downlink and uplink), the BS 204a may reserve the available channel and may instruct the CPE to search for other candidate channels, may wait until a candidate channel is released for use by the CPE, or may request that a channel be released.

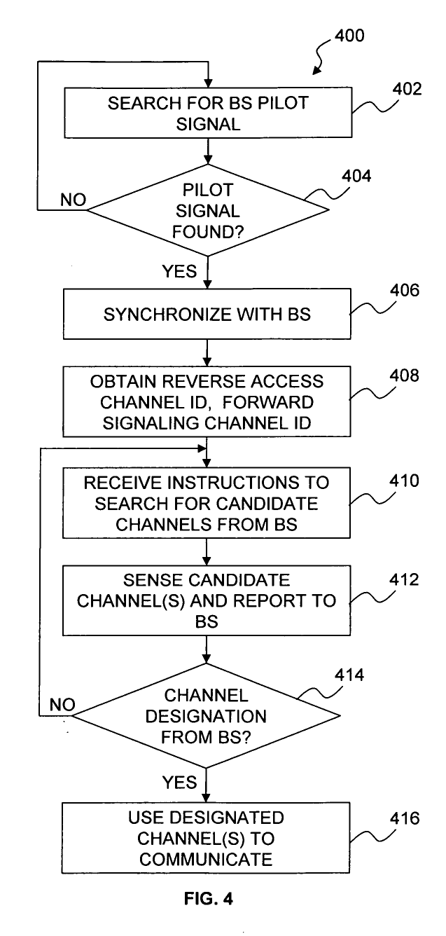

Referring to FIG. 4, in another embodiment, a method 400 may be used by a CPE within a system that uses dynamic frequency assignment, such as the wireless network 200 of FIG. 2. In step 402, the CPE may search for a pilot signal, such as a pilot signal generated by the BS 204a of FIG. 2. In the present example, the CPE may not be allowed to initiate a transmission on any frequency at this time. If no pilot signal is found, as determined in step 404, the CPE may return to step 402 and continue searching. If a pilot signal is found, the method 400 may continue to step 406, where the CPE synchronizes with the BS 204a using information from the pilot signal. It is noted that the CPE may find multiple pilot signals in step 402. If multiple pilot signals were found in step 402, the CPE may identify a primary pilot signal based on signal strength and/or other factors and synchronize with the BS corresponding to the primary pilot signal.

In step 408, the CPE may obtain a RACH ID and/or other RACH information from the pilot signal, along with a FSCH_ID and/or other FSCH information. The CPE may then attempt to associate with the BS 204a using the RACH. In the present example, the CPE may not be allowed to initiate a transmission on any frequency except the RACH at this time. In step 410, the CPE may receive instructions on the FSCH from the BS 204a to search for candidate channels. The instructions may include a set of candidate channels for which the CPE is to search or may instruct the CPE to search for all available channels. In some embodiments, step 410 may be omitted and the CPE may search for available candidate channels without being instructed by the BS 204a. In step 412, the CPE may search for candidate channels and report the channels that are available for use by the CPE, which may include TV frequencies and/or other frequencies.

In step 414, the CPE may determine whether it has received a channel designation from the BS 204a notifying the CPE to use one or more of the candidate channels. If no such channels have been designated, the method 400 may receive instructions to search for other candidate channels (step 410). If the CPE determines that the BS 204a has designated channels for use by the CPE, the CPE may begin to communicate using the designated channels in step 416.

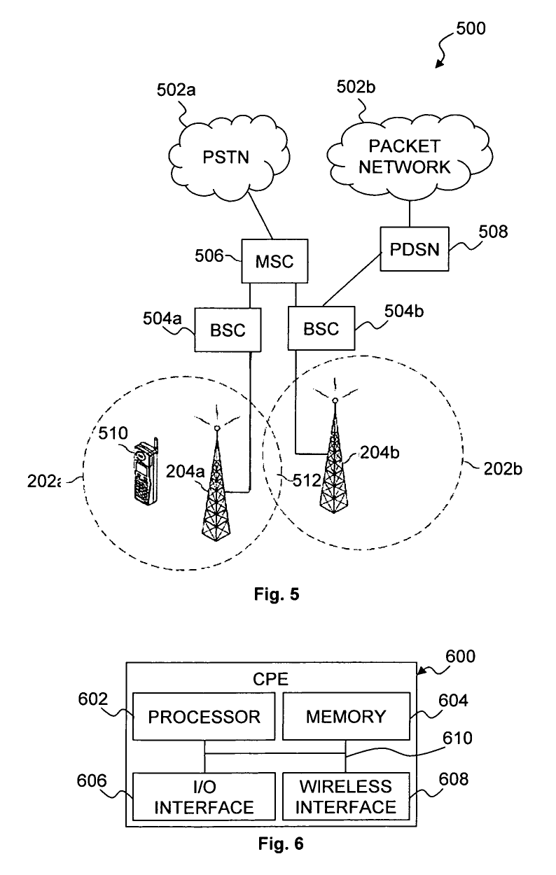

Referring to FIG. 5, a communications network 500 illustrates another embodiment of a system within which the method 100 of FIG. 1 may be executed. In the present example, the network 500 is a time division multiple access (TDMA) network that may be compatible with a variety of standards including, but not limited to, Global System for Mobile communication (GSM), General Packet Radio Service (GPRS), and Enhanced Data Rates for GSM Evolution (EDGE). The network 500 may include WRAN functionality as well as, for example, GSM functionality.

The network 500 includes a plurality of cells 202a, 202b (e.g., the cells 202a and 202b of FIG. 2). In the present example, the network 500 is a wireless network, and may be connected to other wireless and/or wireline networks, such as a Public Switched Telephone Network (PSTN) 502a and a packet network 502b. Each cell 202a, 202b in the network 500 includes a base station (BS) 204a, 204b, respectively, that are coupled to base station controllers (BSC) 504a, 504b, respectively. A mobile switching center (MSC) 506 may be used to connect the network 500 with other networks such as the PSTN 502a. Although not shown, the base stations 204a and 204b may be coupled to the same BSC, and the BSCs 504a and 504b may be coupled to separate MSCs. The BSC 504b may be coupled to a packet-switched node 508 (e.g., a packet data node such as a packet data serving node (PDSN)) that is coupled to the packet network 502b. It is understood that other network components, such as a Gateway Mobile Switching Center (GMSC), Home Location Register (HLR), Visitor Location Register (VLR), Authentication Center (AuC), Equipment Identity Register (EIR), and/or a Short Message Service Gateway, are not shown for purposes of clarity but may be included in the network 500. As such components are well known to those of skill in the art, they are not described in detail herein.

The network 500 enables a wireless device 510 (e.g., a CPE) to communicate with another device (not shown) via the BS 204a associated with the cell 202a in which the CPE is located. Although illustrated in FIG. 5 as a cellular phone, it is understood that the CPE 510 may be any device capable of wirelessly participating in a communication session, and such devices may include personal digital assistants, modems, computers, pagers, and/or telephones. The cells 202a, 202b overlap so that the CPE 510 (if mobile) may travel from one cell to another (e.g., from the cell 202a to the cell 202b) while maintaining a communication session. In a handoff region 512 (e.g., the area where the cells 202a, 202b overlap), the CPE 510 may be serviced by both the BS 204a and the BS 204b. Pilot signals transmitted by the BS 204a and/or 204b, at least for a WRAN portion of the network 500, may include uplink and downlink information as previously described.

Referring to FIG. 6, one embodiment of a simplified CPE 600 is illustrated. The CPE 600 may include a central processing unit (“processor”) 602, a memory unit 604, an input/output (“I/O”) interface 606, and a wireless interface 608. The wireless interface 608 may be, for example, one or more wireless network interface cards (NICs) that are each associated with a media access control (MAC) address. The wireless interface 608 may be coupled directly to a network (not shown) or may be coupled via one or more other networks (not shown). The components 602, 604, 606, and 608 may be interconnected by a bus system 610.

It is understood that the CPE 600 may be differently configured and that each of the listed components may actually represent several different components. For example, the processor 602 may represent a multi-processor or a distributed processing system; the memory unit 604 may include different levels of cache memory, main memory, hard disks, and remote storage locations; and the I/O device 606 may include monitors, keyboards, and the like. Furthermore, although shown within the CPE 600, it is understood that some components (e.g., a keyboard or antenna) may be physically located outside of the CPE 600. In addition, some or all of the components 602, 604, 606, and 608 may be distributed. Therefore, a wide range of flexibility is anticipated in the configuration of the CPE 600.

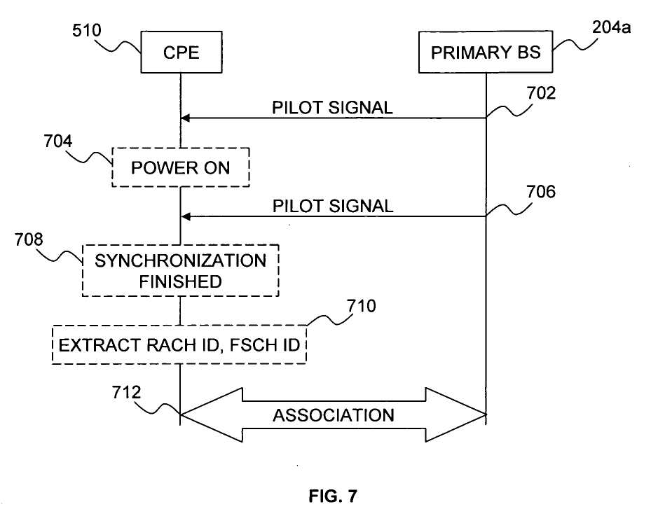

Referring to FIG. 7, in yet another embodiment, a sequence diagram 700 illustrates one possible sequence of events between the CPE 510 and BS 204a of FIG. 5. In the present example, the sequence diagram 700 illustrates the CPE 510 moving from a powered off state to a powered on state. In step 702, the BS 204a is transmitting a pilot signal containing uplink and downlink information as previously described. In step 704, the CPE 510 may be powered on and may detect the pilot signal transmitted by the BS 204a (step 706). The CPE 510 may synchronize with the BS 204a in step 708 and may extract a RACH ID and/or other uplink information as well as an FSCH ID and/or other downlink information from the pilot signal in step 710. In step 712, using the RACH ID and the FSCH ID, the CPE 510 may associate with the BS 204a. It is understood that the CPE 510 may search for and identify candidate channels, report those channels to the BS 204a, and receive instructions to use one or more of the candidate channels from the BS during the sequence illustrated by the sequence diagram 700.

Although only a few exemplary embodiments of this disclosure have been described in details above, those skilled in the art will readily appreciate that many modifications are possible in the exemplary embodiments without materially departing from the novel teachings and advantages of this disclosure. Also, features illustrated and discussed above with respect to some embodiments can be combined with features illustrated and discussed above with respect to other embodiments. For example, various steps from different flow charts may be combined, performed in an order different from the order shown, or further separated into additional steps. Furthermore, steps may be performed by network elements other than those disclosed. Accordingly, all such modifications are intended to be included within the scope of this disclosure.

What is claimed is:

1. A method for a wireless device comprising:
identifying a pilot signal of a base station in a frequency division duplex wireless system;
obtaining a reverse access channel identifier and a forward signaling channel identifier from the pilot signal;
initiating communication with the base station via a reverse access channel corresponding to the reverse access channel identifier;
sensing a set of candidate channels available for use by the wireless device; and
reporting the set of candidate channels to the base station.

2. The method of claim 1 further comprising:
receiving a directive from the base station via a forward signaling channel corresponding to the forward signaling channel identifier to use at least one candidate channel from the set of candidate channels; and
communicating with the base station using the at least one candidate channel.

3. The method of claim 1 further comprising receiving a first directive from the base station to sense the set of candidate channels

4. The method of claim 3 wherein the first directive identifies a plurality of candidate channels to be included within the set of candidate channels to be sensed.

5. The method of claim 3 further comprising receiving a second directive from the base station to sense another set of candidate channels.

6. The method of claim 1 wherein obtaining the reverse access channel identifier from the pilot signal includes obtaining at least one of a frequency of the reverse access channel, a bandwidth of the reverse access channel, a power requirement of the reverse access channel, and a parameter for resolving reverse access channel contention, and wherein obtaining the forward signaling channel identifier from the pilot signal includes obtaining at least one of a frequency of the forward signaling channel and a bandwidth of the forward signaling channel.

7. The method of claim 1 further comprising synchronizing with the base station.

8. A wireless device comprising:
a wireless interface configured to receive and transmit wireless signals;
a processor coupled to the wireless interface;
a memory coupled to the processor and configured to store a plurality of instructions; and
the plurality of instructions including instructions for:
searching for a pilot signal transmitted by a base station in a frequency division duplex wireless network;
obtaining reverse access channel information from the pilot signal;
obtaining forward signaling channel information from the pilot signal;
contacting the base station via a reverse access channel extracted from the reverse access channel information;
receiving a first directive from the base station via a forward signaling channel extracted from the forward signaling channel information to search for a first set of candidate channels;
searching for the first set of candidate channels; and
reporting at least one candidate channel identified during the search for the first set of candidate channels to the base station.

9. The wireless device of claim 8 further comprising instructions for:
receiving a directive from the base station on the forward signaling channel to use the at least one candidate channel; and
communicating with the base station using the at least one candidate channel.

10. The wireless device of claim 8 further comprising instructions for:
receiving a second directive from the base station on the forward signaling channel to search for a second set of candidate channels;
searching for the second set of candidate channels; and
reporting at least one candidate channel identified during the search for the second set of candidate channels to the base station.

11. The wireless device of claim 8 further comprising instructions for preventing a wireless signal from being transmitted via the wireless interface prior to obtaining the reverse access channel information from the pilot signal.

12. A method for use by a base station comprising:
generating a pilot signal in a frequency division duplex wireless system, wherein the pilot signal includes uplink and downlink information;
receiving a message from a wireless device via an uplink channel defined in the uplink information;
instructing the wireless device to sense a first set of candidate channels via a downlink channel defined in the downlink information;
receiving a notification from the wireless device identifying at least one candidate channel available for use by the wireless device from the first set of candidate channels; and
instructing the wireless device to use at least one of the candidate channels from the first set of candidate channels identified as available for use.

13. The method of claim 12 further comprising:
determining if the first set of candidate channels provides an uplink channel and a downlink channel for the wireless device; and
instructing the wireless device to sense a second set of candidate channels if the first set of candidate channels does not provide an uplink channel and a downlink channel for the wireless device.

14. The method of claim 12 wherein the uplink information in the pilot signal includes reverse access channel information and the downlink information includes forward signaling channel information.

15. The method of claim 14 wherein the reverse access channel information includes at least one of a frequency of the reverse access channel, a bandwidth of the reverse access channel, a power requirement of the reverse access channel, and a parameter for resolving reverse access channel contention, and wherein the forward signaling channel information includes at least one of a frequency of the forward signaling channel and a bandwidth of the forward signaling channel.

16. The method of claim 12 further comprising selecting candidate channels from the first set of candidate channels identified as available for use that have lesser amount of adverse impact on another base station than other channels of the first set.

17. A wireless communication system comprising:
a subdivision of a frequency division duplex wireless network;
a base station providing wireless coverage for the subdivision, wherein the base station is coupled to a processor configured to execute instructions stored on a memory, and wherein the instructions include instructions for:
generating a pilot signal containing reverse access channel information and forward signaling channel information;
receiving a message from a wireless device via a reverse access channel defined in the reverse access channel information; and
instructing the wireless device via a forward signaling channel associated with the forward signaling channel information to use first and second frequency channels for downlink and uplink channels, respectively.

18. The wireless communication system of claim 17 further comprising instructions for:
instructing the wireless device to sense a plurality of candidate channels, wherein the plurality of candidate channels include the first and second frequency channels; and
receiving a notification from the wireless device identifying the first and second frequency channels as having been sensed by the wireless device as suitable for use by the wireless device.

19. The wireless communication system of claim 18 further comprising instructions for dividing the plurality of candidate channels into a first set of candidate channels and a second set of candidate channels.

20. The wireless communication system of claim 19 wherein the instructions for instructing the wireless device to sense a plurality of candidate channels includes sending the first set of candidate channels to the wireless device and sending the second set of candidate channels to the wireless device only if the first and second frequencies are not in the first set.
